(19) United States
(12) Patent Application Publication
(10) Pub. No.: US 2008/0055906 A1
(43) Pub. Date: Mar. 6, 2008

(54) Light-emitting device for bathroom containers

(76) Inventor: Ming-Kuei Lin, Panchiao City (TW)

Correspondence Address: TROXELL LAW OFFICE PLLC, SUITE 1404, 5205 LEESBURG PIKE, FALLS CHURCH, VA, 22041, US

(21) Appl. No.: 11/514,334

(22) Filed: Sep. 1, 2006

(51) Int. Cl. F21V 33/00

(52) U.S. Cl. 362/253

(57) ABSTRACT

A light-emitting device for bathroom containers is disclosed. Two contiguous and separated rooms are arranged in a main body of bathroom containers. A first room can be see-through from outside and has a plurality of irregular refraction surfaces while the second room is arranged with electronic components including a LED(light-emitting diode) circuit, a battery holder, a vibration switch and a plurality of LEDs whose light is projected into inner space of the first room. When the container is used and having vibration, the LED is turned on by the vibration switch so that light emits from the LED and projects into the inner space of the first room and colorful dynamic reflective light is displayed outwards. Therefore, the novelty as well as decorative effect of the bathroom,containers is increased.

### BACKGROUND OF THE INVENTION

The present invention relates to a light-emitting device for bathroom containers, especially to a container with light-emitting diode (LED) lamps that are turned on when the container is used or vibrated so as to project light into a space inside the container for displaying colorful reflective light.

Besides original functions, bathroom accessories such as lotion bottles, toothbrush holders or tumblers also have various styles so as to increase novelty or decorative effect. For example, U.S. Pat. No. 6,179,153, U.S. Pat. No. 6,340,099, U.S. Pat. No. 6,193,106, U.S. Pat. No. 6,105,819, U.S. Pat. No. 6,155,411 all disclose containers disposed with a transparent close space that can be seen through from outside. A dual-liquid with decorating floater is arranged inside the space. The dual-liquid consists of a bottom layer such as water and a top layer such as oil while solid floaters swim between the two layers of liquid. However, floaters in the space in such kind of design only move when the container has certain degrees of shaking or vibration. Such kind of dynamic effect can't last too long and shortly turns back to static condition. Moreover, there is no light in general containers so that such kind of dynamic can't be displayed outwards. In other words, it seems no difference on appearance of the containers while being used or not. The novelty and decorative effect of the container are not efficiently improved.

### SUMMARY OF THE INVENTION

Therefore it is a primary object of the present invention to provide a light-emitting device of bathroom containers. Two contiguous and separated rooms are arranged in a main body of bathroom containers. A first room can be see-through from outside and has a plurality of irregular refraction surfaces while the second room is arranged with electronic components including a LED (light-emitting diode ) circuit, a battery holder, a vibration switch and a plurality of LEDs (light-emitting diode )whose light is projected into inner space of the first room. When the container is used and having vibration, the LED is turned on by the vibration switch so that light emits from the LED and projects into the inner space of the first room. Then by refraction or reflection of the irregular refraction surfaces in the first room, a colorful dynamic reflective light is displayed outwards so as to increase the novelty as well as decorative effect of the bathroom containers.

It is another object of the present invention to provide a light-emitting device of bathroom containers in which the irregular refraction surfaces inside the first room are formed by a plurality of transparent plastic blocks with irregular shapes, arranged randomly in liquid. The irregular refraction surfaces can also be formed by a plurality of colorful lustrous foil fragments floating inside liquid. Therefore, light emitted from LED and projected into the first room is refracted or reflected and then displayed outwards.

### BRIEF DESCRIPTION OF THE DRAWINGS

FIG. 1 is a perspective view of an embodiment according to the present invention;

FIG. 2 is an explosive view of an embodiment in FIG. 1;

FIG. 3 is a lateral sectional view of an embodiment in FIG. 1;

FIG. 4 is a perspective view of another embodiment according to the present invention;

FIG. 5 is an explosive view of an embodiment in FIG. 4;

FIG. 6 is a perspective view of a further embodiment according to the present invention.

### DETAILED DESCRIPTION OF THE PREFERRED EMBODIMENT

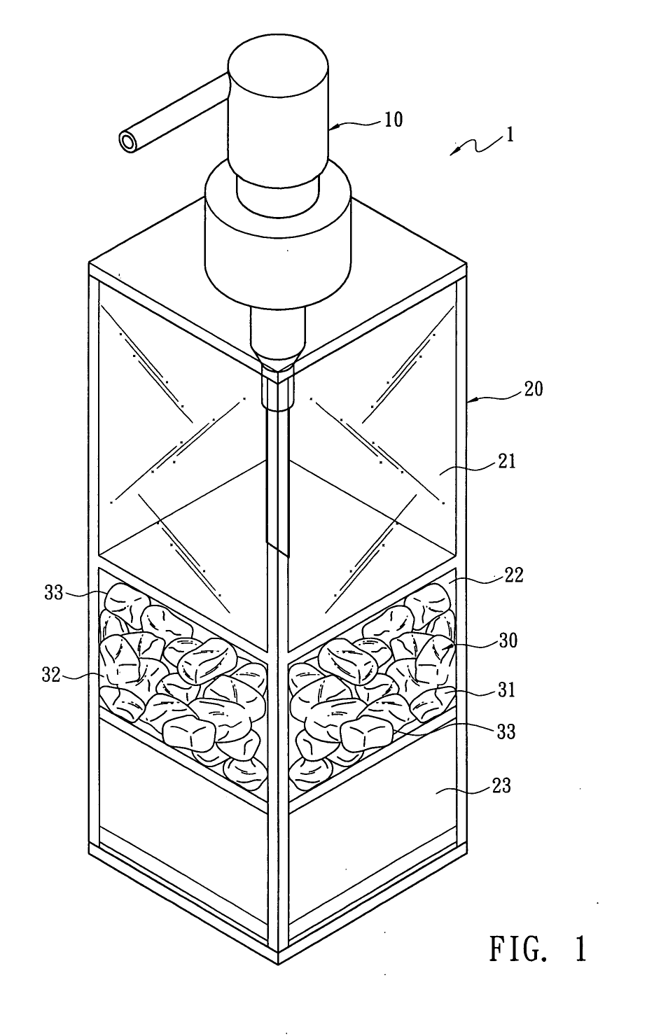

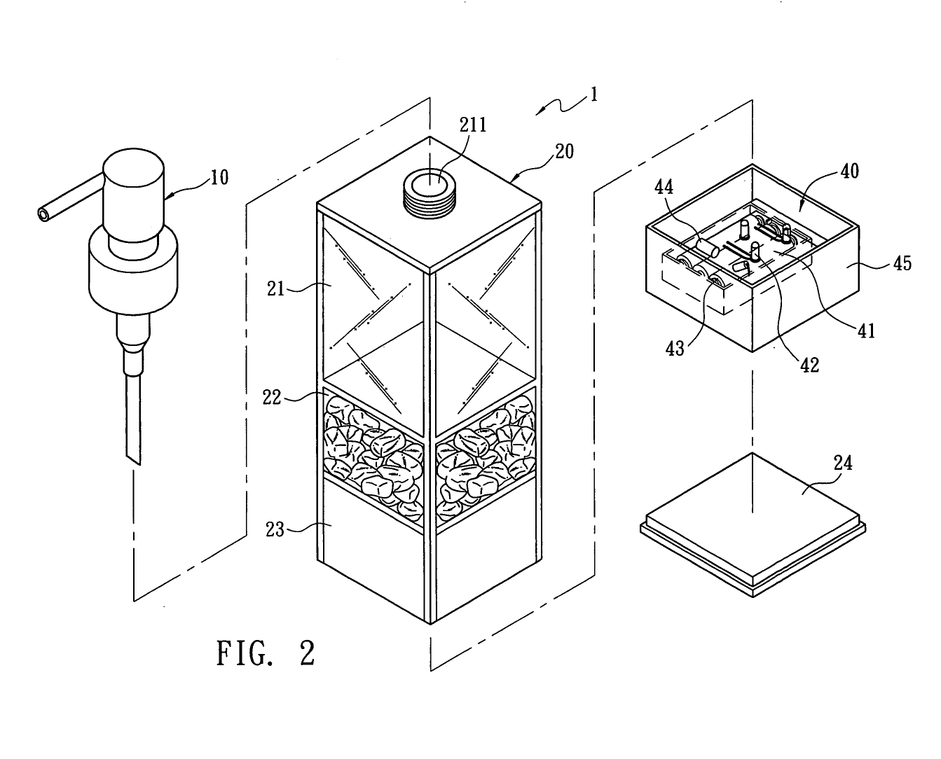

In the present invention, bathroom containers include lotion bottles, toothbrush holder or tumblers. Take a lotion bottle 1 as an example. Refer from FIG. 1 to FIG. 3, the lotion bottle 1 consists of a lotion pump 10 and a main body 20. A tank 21 for setting lotion is disposed on an upper part of the main body 20 while the lotion pump 10 is threaded on an opening 211 above the tank 21 and the tube inserts into the bottom of the tanks 21 so that users can get lotion inside the tank 21 by the lotion pump 10.

The present, invention features on that two contiguous and separated rooms—a first room 22 and a second room 23 are arranged on main body 20 of the container. The first room 22 is a transparent, see-through space with a plurality of irregular refraction surfaces 30 therein, located on a middle part of the main body 20 while the second room 23 is positioned on a lower part of the main body 20 and is disposed with electronic components 40 including a LED circuit board 41 for controlling light emitting patterns of a plurality of LEDs 42, the plurality of LEDs 42 in the same or different color disposed on the LED circuit board 41, a battery holder 42 for accommodating batteries as a power source and a vibration switch 44 arranged on the LED circuit board 41. The LEDs 42 face the first room 22 so that light emitted therefrom passes through a transparent baffle 24 between the first and the second rooms 22, 24 and projects into the inner space of the first room 22. When the lotion bottle 1 is used and vibrated such, as being pressed on the lotion pump 10, the LEDs 42 is turned on by the vibration switch 44 so that light emits from the LEDs 42 and projects into the inner space of the first room 22.

By refraction or reflection of the irregular refraction surfaces 30 inside the first room 22, a colorful dynamic reflective light is generated and is displayed outwards so as to increase the novelty and decorative effect of the bathroom containers.

There is no limit on manufacturing or molding way of the main body 20. The positions of the tank 21, the first room 22 and the second room 23 can be changed with one another. For example, they can be arranged linearly-from top to bottom sequentially are the tank 21, the first room 22 and the second room 23, as shown from FIG. 1 to FIG. 3. Or from top to bottom sequentially are the tank 21, the second room 23 and the first room 22 (not shown in figure). They can also be arranged in transverse direction while the first room 22 and the second room 23 respectively are on one side of the tank 21. The main body is produced by plastic injection molding, in combination with ultrasonic welding so as to achieve mass-produced purpose. Moreover, the electronic components 40 can be disposed in an opened box 45 in advance for convenience of assembling and then is set into the second room 23. Then a bottom cap 24 is covered on bottom of the second room 23. There is no restriction on the connection way between the bottom cap 24 and the bottom of the second room 23. For example, they can be joined with each other by ultrasonic welding or by fastening so that the bottom cap 24 can be opened from outside repeatedly for replacing batteries.

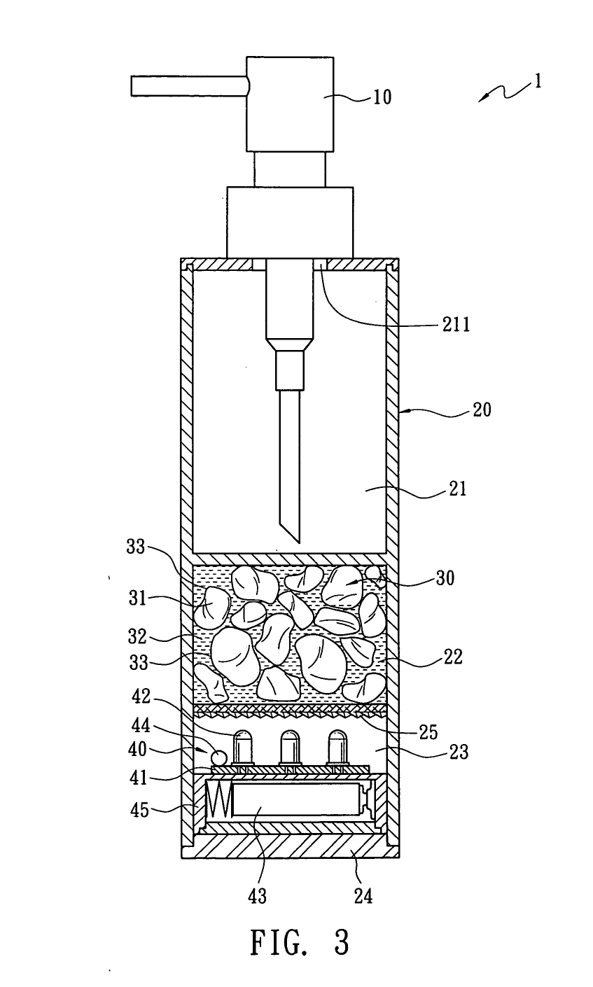

The second room 23 or the box 45 is not transparent so as to avoid the influence of the electronic components 40 on appearance of the device. Furthermore, the transparent baffle 25 between the first room 22 and the second room 23 is arranged with uneven surfaces, as shown in FIG. 3. Thus light from LED 42 in the second room 23 passes through the baffle 25 and projects into the first room 22. It should be avoided to see the electronic components 40 inside the second room 23 through the baffle 25.

Furthermore, when the vibration switch 44 is turned on, the lighting patterns of the LEDs 42 are controlled by the LED circuit board 41. For example, the LEDs 42 emit light simultaneously, in alternating way, flickeringly, or for a period of time such as one to three minutes and then stops automatically. Thus the novelty and decorative effect of the device are increased.

In addition, the way to form the irregular refraction surfaces 30 in the first room 22 is not limited. The irregular refraction surfaces 30 can be formed by a plurality of transparent plastic blocks 31 with irregular shapes, arranged randomly in liquid 32, as shown in FIG. 3. The irregular refraction surfaces 30 can also be formed by a plurality of colorful lustrous foil fragments floating inside liquid (not shown in figure) so that the surface of each lustrous foil fragment becomes a refraction surface. Thereby, light emitted from LED 42 and projected into the first room 22 is refracted or reflected by the irregular refraction surfaces 30 and then displayed outwards.

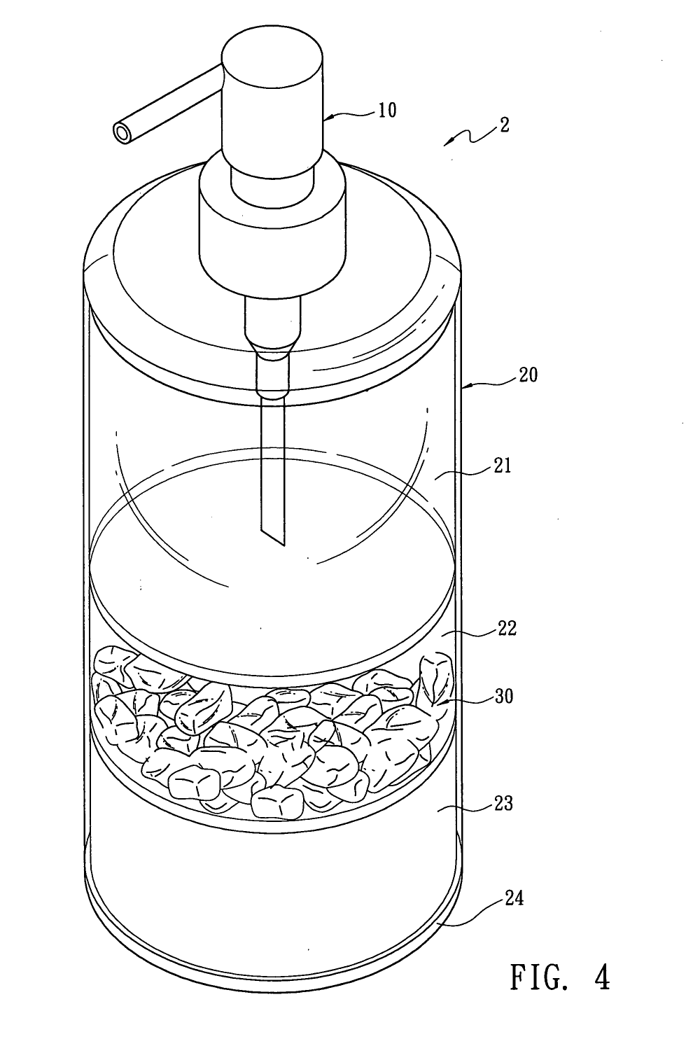

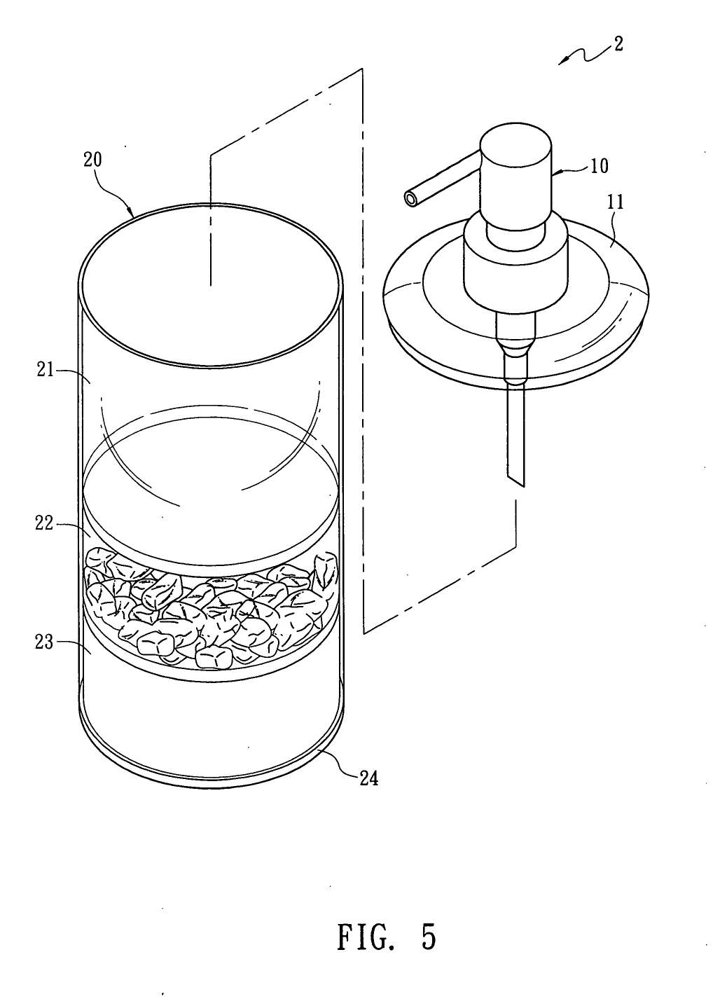

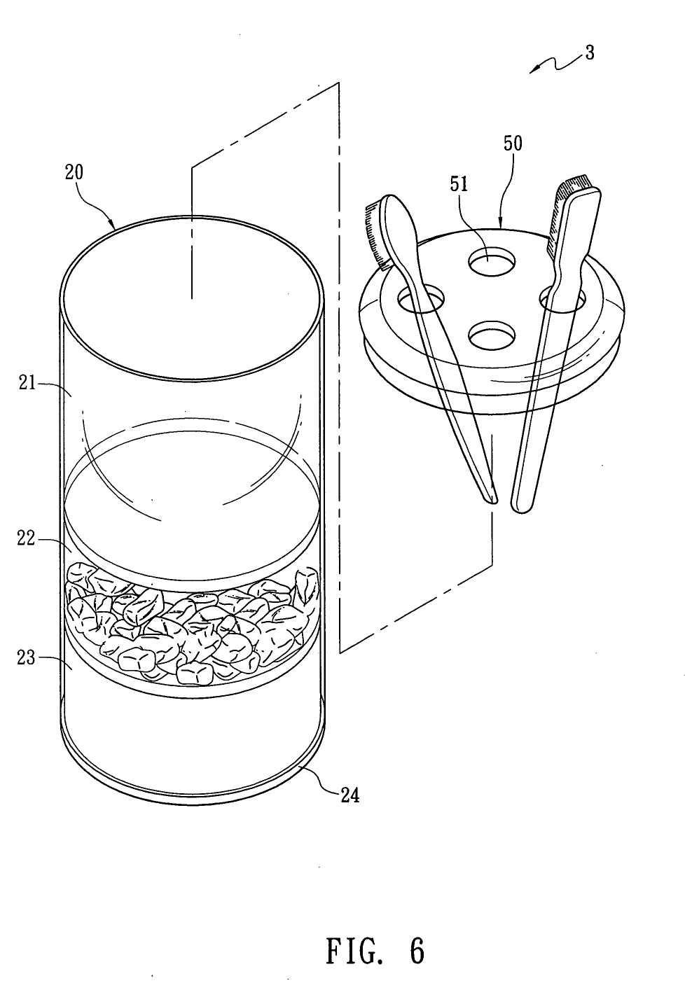

Refer from FIG. 4 to FIG. 6, a lotion body of another embodiment according to the present invention has the same features with the lotion bottle 1 of the above embodiment and the difference between them is the assembling way. The tank 21 of the main body 20 has an opening with large diameter so that the main body 20 can be used as a tumbler, as shown in FIG. 5 & FIG. 6. Refer to FIG. 5, the lotion pump 10 is threaded on a top cap 11 firstly, and then the top cap 11 is covered firmly on the opening above the tank 21 of the main body 20 so as to form a lotion bottle 2, as shown in FIG. 4. Refer to FIG. 6, a cap for toothbrush 50 with a plurality of hole 51 for insertion of the toothbrush is covered on the opening above the tank 21 of the main body 20 so as to form a toothbrush holder 3.

Additional advantages and modifications will readily occur to those skilled in the art. Therefore, the invention in its broader aspects is not limited to the specific details, and representative devices shown and described herein. Accordingly, various modifications may be made without departing from the spirit or scope of the general inventive concept as defined by the appended claims and their equivalents.

What is claimed is:

1. A light-emitting device for bathroom containers comprising a main body disposed with a tank; the device is characterized in that: two contiguous and separated rooms are arranged in the main body; wherein a first room is able to be see-through from outsides and is disposed with a plurality of irregular refraction surfaces therein while a second room is arranged with electronic components including a LED(light-emitting diode) circuit, a battery holder, a vibration switch and a plurality of LEDs whose light projects into inner space of the first room; while the containers being used and vibrated, the LED is turned on by the vibration switch and light emits from the LED and projects into the inner space of the first room; by refraction or reflection of the irregular refraction surfaces, a colorful dynamic reflective light is displayed outwards for increasing novelty and decorative effect of the bathroom containers.

2. The device as claimed in claim 1, wherein the bathroom containers comprises lotion bottles, toothbrush holders or tumblers.

3. The device as claimed in claim 1, wherein the tank is disposed on an upper part of the main body with an opening facing upwards while the first room is arranged on a middle part of the main body, under the tank and the second room is located on a lower part of the main body, under the first room.

4. The device as claimed in claim 1, wherein a transparent baffle between the first room and the second room is arranged with uneven surfaces.

5. The device as claimed in claim 1, wherein the irregular refraction surfaces in the first room are formed by a plurality of transparent plastic blocks with irregular shapes, arranged freely in liquid.

6. The device as claimed in claim 1, wherein the irregular refraction surfaces in the first room are formed by a plurality of colorful lustrous foil fragments floating inside liquid.
